(19) United States
(12) Patent Application Publication
(10) Pub. No.: US 2014/0315031 A1
(43) Pub. Date: Oct. 23, 2014

(54) SILICONE COATING MATERIAL AND TRANSPARENT SUBSTRATE HAVING HEAT-SHIELDING STRUCTURE

(71) Applicants: Hiromitsu Furuichi, Kaizu-shi (JP); Hiroyas Tsuge, Aichi (JP); Makoto Murase, Aichi (JP)

(72) Inventors: Hiromitsu Furuichi, Kaizu-shi (JP); Hiroyas Tsuge, Aichi (JP); Makoto Murase, Aichi (JP)

(21) Appl. No.: 13/865,061

(22) Filed: Apr. 17, 2013

(51) Int. Cl. C09D 5/00

(52) U.S. Cl. CPC C09D 5/00
USPC 428/447; 106/287.14

(57) ABSTRACT

An object of the present invention is to provide a silicone coating material which, when applied to a transparent substrate such as glass, can provide a coating film which is excellent in surface uniformity and adhesion, has high hardness, and has characteristics capable of sufficiently shielding heat rays such as near-infrared rays. The silicone coating material comprises a silane solution comprising an alkoxysilane hydrolysate and a dispersion of indium tin oxide (ITO) (ITO dispersion), the solution and the dispersion being mixed for service. ITO particles in the ITO dispersion are silane-treated. The silane treatment agent (silane coupling agent) in the silane treatment is preferably an ω-glycidoxyalkylalkoxysilane represented by general formula (I):

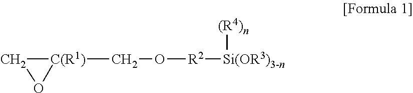

wherein R¹ and R⁴ each represent H or CH₃; R² represents an alkylene group having 1 to 4 carbon atoms; R³ represents an alkyl group having 1 to 4 carbon atoms; and n=0 or 1.

### BACKGROUND OF THE INVENTION

1. Field of the Invention

The present invention relates to a silicone coating material comprising: a silane solution comprising an alkoxysilane hydrolysate; and an aqueous dispersion of indium tin oxide (ITO) particles (hereinafter referred to as an “ITO dispersion”), the solution and the dispersion being mixed for service. The present invention particularly relates to a silicone coating material suitable as a heat-shielding coating material.

2. Description of the Related Art

A heat-shielding coating material is mentioned as an example of techniques and products developed with energy saving and cost saving strongly in mind.

The feature of the heat-shielding coating material is in that near-infrared rays (heat rays) incident on the interior of a room can be shielded and an increase in room temperature can be suppressed to some extent by the application of the heat-shielding coating material to a window glass (transparent substrate) of a building and the like. For example, the amount of air-conditioning usage in summer may be reduced utilizing this feature, which can contribute to a reduction in power consumption.

Based on such a background, one of the applicants of the present invention has developed and sold a product in which an ITO dispersion is mixed with a synthetic resin (an acrylic resin and an acrylic siloxane crosslinkable reactive polymer) as a heat-shielding coating material (Japanese Patent Laid-Open No. 2007-106826 (Abstract, Claim 1)).

It has been found that, in order to extend the applicability of the heat-shielding coating material, a heat-shielding coating film formed from the heat-shielding coating material needs to achieve the following target performance by room-temperature drying (room-temperature curing).

1) The coating film is uniform and close, and the surface does not have a defect such as fracture and peeling;

2) The coating film is not peeled off at all in the peeling test with a pressure sensitive adhesive tape;

3) The pencil hardness is 5H or more (hardness by which practical abrasion resistance is obtained);

4) There are no surface defects after a heat resistance test (100° C.×30 min); and

5) Near-infrared rays (particularly, in a wavelength region of about 1500 to 2600 nm) can be reliably shielded.

Although the patentability of the present invention is not affected, prior art literatures relating to a heat-shielding coating material containing indium tin oxide (ITO) particles to shield heat rays include National Publication of International Patent Application No. 2005-511292 (Abstract, Claims 8 and 21), Japanese Patent Laid-Open No. 2005-121759 (Abstract, Claims 2 and 6), Japanese Patent Laid-Open No. 2006-291136 (Abstract, Claims 1 and 4), Japanese Patent Laid-Open No. 2008-297414 (Abstract, Claim 2), and Japanese Patent Laid-Open No. 2009-13358 (Abstract, Claims 1 and 2).

In view of the above description, an object of the present invention is to provide a silicone coating material which, when applied to a transparent substrate such as glass, can form a heat-shielding coating film which has characteristics capable of sufficiently shielding heat rays such as near-infrared rays and far-infrared rays, is excellent in surface uniformity and adhesion, has practical abrasion resistance, and has practical heat resistance.

### SUMMARY OF THE INVENTION

As a result of exhaustive efforts to achieve the above object, the present inventors conceived of the idea of a silicone coating material having the following constitution.

The silicone coating material comprises a silane solution comprising an alkoxysilane hydrolysate and an ITO dispersion, the solution and the dispersion being mixed for service, wherein the ITO dispersion is a modified-ITO dispersion to which a silane treatment agent is added and mixed.

The silicone coating material of the present invention can form a heat-shielding coating film which has characteristics capable of sufficiently shielding heat rays such as near-infrared rays, is excellent in surface uniformity and adhesion, has practical abrasion resistance, and has practical heat resistance.

Furthermore, the silicone coating material of the present invention has a practical life as a coating material (gelation time: about 3 days or more) in a state where the silane solution and the modified-ITO dispersion are mixed.

### BRIEF DESCRIPTION OF THE DRAWINGS

FIG. 1 is a view showing model structural formulas of various silane treatment agents used in Examples (Test Examples) of the present invention;

FIG. 2 is a transmittance curve in a wavelength range of 800 to 2600 nm when a heat-shielding coating film of a silicone coating material of one Example of the present invention is formed on a glass substrate; and

FIG. 3 is a SEM (scanning electron microscope) photograph of the surface FIG. 3A and the cross section FIG. 3B of a heat-shielding coating film formed similarly on the glass substrate.

### DETAILED DESCRIPTION OF THE PREFERRED EMBODIMENTS

Hereinafter, the embodiments of the present invention will be described in detail. In the following description, the formulation unit and the addition ratio are based on mass, unless otherwise specified.

The present invention provides a silicone coating material comprising: a silane solution comprising an alkoxysilane hydrolysate; and a modified-ITO dispersion, the solution and the dispersion being mixed for service, wherein the silicone coating material constitutes a generic concept.

### (1) Modified-ITO Dispersion:

The modified-ITO dispersion is obtained by adding and mixing a silane treatment agent in an ITO dispersion in which untreated ITO particles are dispersed (thereby effecting a silane treatment reaction for a predetermined time).

The average particle size (median value) of the ITO particles is preferably 0.2 μm or less, more preferably 0.1 μm or less, further preferably 0.04 μm or less. This is for ensuring good transparency (Japanese Patent Laid-Open No. 2009-13358, paragraph 0012).

The ITO preferably has a Sn ratio [Sn/(Sn+In)] of 1 to 20%. If the Sn ratio is less than 1%, the heat ray-shielding performance will be difficult to be obtained, and the dispersion will be expensive because the In component increases. When the Sn ratio exceeds 20%, it will be difficult to obtain the heat ray-shielding performance as in the above case (Japanese Patent Laid-Open No. 2009-13358, paragraph 0013).

The ITO dispersion is obtained by dispersing 25 to 45% (preferably 30 to 40%) of ITO particles in a dispersion medium. An aqueous dispersion medium such as IPA is generally used as a dispersion medium. The ITO particles can be stably dispersed when they are dispersed in the range as described above. Commercially available products can be used as the ITO dispersion.

The silane treatment agent (silane coupling agent) used here is one or more selected from the group consisting of an ω-glycidoxyalkylalkoxysilane represented by general formula (I):

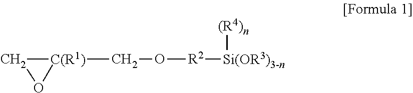

wherein R¹ and R⁴ each represent H or CH₃; R² represents an alkylene group having 1 to 4 carbon atoms; R³ represents an alkyl group having 1 to 4 carbon atoms; and n=0 or 1, and a trialkoxysilane represented by general formula (II):

R⁵Si(OR⁶)₃

wherein R⁵ and R⁶ each represent an alkyl group having 1 to 4 carbon atoms.

Among these, ω-glycidoxyalkyltrialkoxysilane in which n=0 in general formula (I) desirably provides higher surface hardness than ω-glycidoxyalkyldialkoxymonoalkylsilane in which n=1 in the same formula and further higher coating film adhesion than the monoalkyltrialkoxysilane represented by general formula (II). Therefore, ω-glycidoxyalkyltrialkoxysilane is preferred. Widely used 3-glycidoxypropyltrimethoxysilane and 3-glycidoxypropyl(dimethoxy)methylsilane can be suitably used as the silane treatment agent represented by general formula (I), and methyltrimethoxysilane can be suitably used as the silane treatment agent represented by general formula (II).

The silane treatment agent is added to the ITO dispersion in an addition ratio of the silane treatment agent to ITO particles (solids) of preferably 3 to 25%, more preferably 5 to 15%, further preferably 8 to 12%. If the addition ratio of the silane treatment agent is too low, cloudiness will be easily generated in the coating film. Conversely, if the addition ratio of the silane treatment agent is too high, it will be difficult for the coating film to obtain desired hardness.

The time for silane treatment (stirring and mixing) varies depending on the treatment temperature, the type and concentration of the silane treatment agent, and the like. When the treatment temperature is room temperature and the silane treatment agent is ω-glycidoxyalkyltrialkoxysilane, the time for silane treatment is 10 to 30 h, preferably 15 to 20 h.

When the time for silane treatment is too short, it is difficult to obtain a uniform silicone coating film. This is presumably because it is difficult to obtain a sufficient bonding density of the alkoxysilane hydrolysate to the ITO particles, and the unreacted components of the silane treatment agent remain in the modified-ITO dispersion.

The temperature for silane treatment may be room temperature to a little higher temperature of 50° C. or less. If the treatment temperature is too high, gelation will easily occur in the hydrolysis reaction of the silane treatment agent.

### (2) Silane Solution:

The silane solution is all or the main body of the coating film-forming ingredients (coating film-forming resin) in the silicone coating material of the present invention.

The silane solution may comprise only a hydrolysate of a tetraalkoxysilane (component A) represented by general formula (III): Si(OR⁷)₄ wherein R⁷ represents an alkyl group having 1 to 4 carbon atoms.

However, preferred is a mixed silane solution comprising a mixed hydrolysate of the tetraalkoxysilane (component A) as well as a trialkoxymonoalkylsilane (component B) represented by general formula (II): R⁵Si(OR⁶)₃ wherein R⁵ and R⁶ each represent an alkyl group having 1 to 4 carbon atoms. The resistance to heat and mechanical impact of the coating film is improved.

Here, general-purpose tetraalkoxysilanes and trialkoxymonoalkylsilanes can be generally used. For example, tetraethoxysilane (TEOS) and methyltrimethoxysilane (MTMOS) are preferred.

The mixed molar ratio of the component B to the component A (component B/component A) is preferably 5/95 to 35/65, more preferably 25/75 to 35/65. That is, when only a tetraalkoxysilane is used, the resulting coating film will have high hardness, but it will be brittle and have low resistance to heat and mechanical impact. Therefore, it is necessary to impart flexibility to the coating film and to increase the resistance to heat and mechanical impact thereof by mixing a trialkoxysilane in a suitable molar ratio. However, if the trialkoxysilane is excessive, it will be difficult for the resulting coating film to attain desired hardness, and the resulting coating film will be liable to have a problem of abrasion resistance.

Note that the silane solution or the mixed silane solution (hydrolysate) is prepared under conditions of, for example, 65 to 75° C.×1.5 to 5 h, preferably 65 to 75° C.×3.5 to 4.5 h. As the preparation time is increased, the hydrolysis sufficiently proceeds, improving the adhesion to a substrate (glass) and the heat resistance of the silicone coating film. Note that general-purpose hydrochloric acid is used as a hydrolysis catalyst from the viewpoint of the stability of the silane solution.

### (3) Preparation of Silicone Coating Material:

The modified (silane-treated) ITO dispersion and the silane solution are mixed to prepare the silicone coating material of the present invention.

The volume mixing ratio of the modified-ITO dispersion to the silane solution (modified-ITO dispersion/silane solution) is preferably 25/75 to 55/45, more preferably 25/75 to 45/55. Note that here the concentration of the silane solution is 0.5 to 1.5 M; and the solids concentration of the modified-ITO dispersion is 25 to 45% (preferably, 30 to 40%).

If the ratio of the modified-ITO dispersion is too low or too high, the gelation time of the coating material will tend to be shorter, which makes it difficult to obtain a practical pot life of the coating material. Note that if a gelled coating material is used, the resulting coating film will become cloudy, and it will be difficult to obtain a smooth coating film surface (refer to Table 1).

### (4) Formation of Silicone Coating Film:

The thus prepared silicone coating material can form a silicone coating film (heat-shielding coating film) of the present invention generally by applying the coating material to a glass substrate and drying it at room temperature for 1 day. The coating material may be optionally heat-treated (for example, 90 to 100° C.×30 to 60 min) from the viewpoint of the acceleration of drying/curing.

Note that the coating method is not particularly limited. Conventional methods such as spray coating, roller coating, and brush coating can be applied. When the coating material is applied in a factory, immersion coating, flow coating, and the like are possible.

The coating film thickness of the silicone coating material at this time is 200 to 2000 nm, preferably 500 to 1500 nm. When the coating film thickness is smaller than the above range, heat-shielding effect and coating film hardness tend to be hardly obtained. Conversely, even if the coating film thickness is increased exceeding the above range, a further improvement in the performance cannot be expected, or the coating film may have an excessive quality. That is, the coating cost increases.

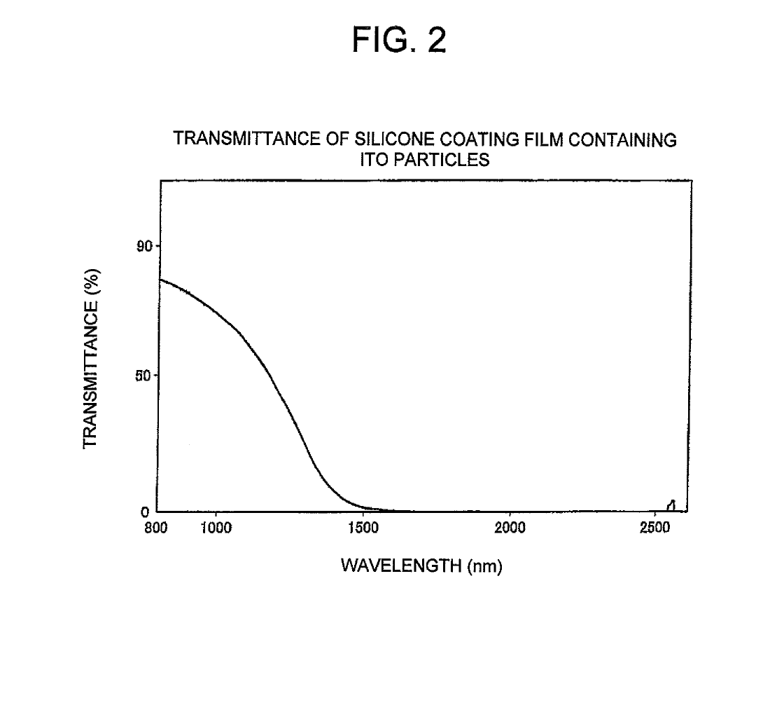

When a silicone coating film (heat-shielding coating film) is formed on a transparent substrate such as a glass substrate in this way, good heat-shielding properties can be imparted to the transparent substrate by shielding the heat-ray wavelength range (1500 nm or more) as shown in Examples to be described below (FIG. 2), and the adhesion of the heat-shielding coating film to the transparent substrate such as glass is also good.

The heat-shielding coating film of the present invention formed in this way has advantages over conventional heat-shielding coating films formed from a heat-shielding coating material in which an ITO dispersion is mixed with a synthetic resin, in that the inventive film has a small coating film thickness (for example, a conventional film has a thickness of around 10 μm, while the inventive film has a thickness of around 1 μm) and also has high hardness (for example, a conventional film has a pencil hardness of 4 to 5H, while the inventive film has a pencil hardness of around 8H).

Hereinafter, the present invention will be described in more detail with reference to Examples.

### A. PREPARATION OF TEST PIECE

### (A-1) Preparation of Silane Solution (Alkoxysilane Hydrolysate)

### (a) When Hydrochloric Acid was Used

To TEOS having a molar concentration of 1 M (ethanol solution), were added hydrochloric acid (0.2 N) and water so that a molar ratio of TEOS:HCl:water of 1:0.01:4 is obtained, thus obtaining a composition for hydrolysis.

The composition for hydrolysis was heated and stirred at 70° C. for 2 h to prepare a silane solution (a-1).

Further, when TEOS and MTMOS were used in combination as a silane component (alkoxysilane), the total molar concentration of both components was set to 1 M, and mixed silane solutions (c-1, c-2, and c-3) were prepared in the same manner as in the case where only TEOS was used. Note that the mixed molar ratios of the mixed silane solutions c-1, c-2, and c-3 were set at 3 ratios of MTMOS/TEOS of 10/90, 20/80, and 30/70.

### (b) When Acetic Acid was Used

To the TEOS having a molar concentration of 1 M (ethanol solution), was added an aqueous acetic acid solution so that a molar ratio of TEOS:acetic acid:water of 1:3:4 is obtained, thus obtaining a composition for hydrolysis. The composition for hydrolysis was heated and stirred at 70° C. for 2 h in the same manner as in the case of hydrochloric acid to prepare a silane solution (b).

### (A-2) Preparation of Modified-ITO Dispersion

To an ITO dispersion (35%, specific gravity: 1.15, dispersing solvent: IPA), was added each of various silane treatment agents (silane coupling agents) in a suitable mass ratio (relative to ITO particles). The dispersion to which the treatment agent is added was stirred at room temperature for about 17 h and mixed (silane-treated) to obtain a modified-ITO dispersion (surface-modified ITO particle-containing dispersion).

### (A-3) Preparation of Silicone Coating Material

The silane solution and the modified-ITO dispersion which were prepared in the above (A-1) and (A-2), respectively, were mixed in a predetermined mixing ratio and stirred at room temperature for 1 h to prepare each silicone coating material.

### (A-4) Preparation of Test Piece for Coating Film Evaluation

With respect to the substrate for test pieces, the glass substrate used for evaluating the coating film surface characteristics had a size of about 15 mm×12 mm×1.2 mm (thickness), and the glass substrate used for measuring the transmittance had a size of about 30 mm×20 mm×1.2 mm (thickness). These glass substrates had been successively washed with acetone and ethanol.

The coating material obtained in the above (A-3) was dropwise added to the top of each glass substrate in an amount of 6 μL for evaluating the coating film surface characteristics or 20 μL for measuring the transmittance, followed by drying at room temperature for 1 day to prepare a test piece.

### B. TEST METHODS, RESULTS, AND DISCUSSION

(B-0) Evaluation Tests of the Following Items were Performed for Each Test Piece Prepared in the Above A.

(I) State of coating film surface: Visual observation was performed using an optical microscope and a scanning electron microscope (SEM).

(II) Adhesion: A peeling test with a pressure sensitive adhesive tape was performed. Specifically, a pressure sensitive adhesive tape was stuck to the coating film surface, and the state of the coating film surface after peeling the tape was visually observed.

(III) Hardness: Pencil hardness was measured.

(IV) Heat resistance: The test piece was put into a dryer and subjected to a heat resistance test under a condition of 100° C.×30 min, and the state of the coating film surface after the test was visually observed.

(V) Transmittance: The transmittance was measured in a wavelength range of 800 to 2600 nm using a spectrophotometer (“340S” manufactured by Hitachi, Ltd.).

### (B-1) Evaluation of Silane Solution

Silane solutions (a-1) and (b) prepared according to the (A-1) (a) and (b), respectively, were each mixed with a modified-ITO dispersion.

The mixtures in various mixing ratios in the range of a modified-ITO dispersion/silane solution (volume mixing ratio) of 20/80 to 80/20 were stirred at room temperature for 1 h to prepare silicone coating materials.

Each of the coating materials was used to form a coating film on a glass substrate according to the (A-4) as described above.

As a result, when the silane solution (a-1) was used, waviness (a stripe-shaped pattern) was observed on the coating film surface, or there was observed a part in which the coating film was cracked and peeled at an edge part of the glass substrate after drying at room temperature for 1 day.

On the other hand, when the silane solution (b) was used, the solution became a little nonuniform as the color of the mixed solution changed from dark blue resulting from the modified-ITO dispersion to bluish white, and in addition the gelation occurred earlier than in the case of the silane solution (a-1). Incidentally, the state of the resulting coating film was as practically equal as in the case of the silane solution (a-1).

These results showed that when a modified-ITO dispersion was added to the silane solution, a silane solution in which hydrochloric acid was used as an acid was excellent in the stability of the resulting solution compared with that in which acetic acid was used. However, it was found that preparation of a stable mixed solution and formation of a uniform coating film were difficult only by mixing the silane solution and the modified-ITO dispersion.

### (B-2) Evaluation and Selection of Silane Treatment Agent for the Preparation of Modified-ITO Dispersion

In order to improve the stability of a mixed solution of a silane solution and a modified-ITO dispersion (silicone coating material), various silane treatment agents (silane coupling agents) were added to and mixed with the ITO dispersion to determine the effect of the chemical modification of the surface of the ITO particles.

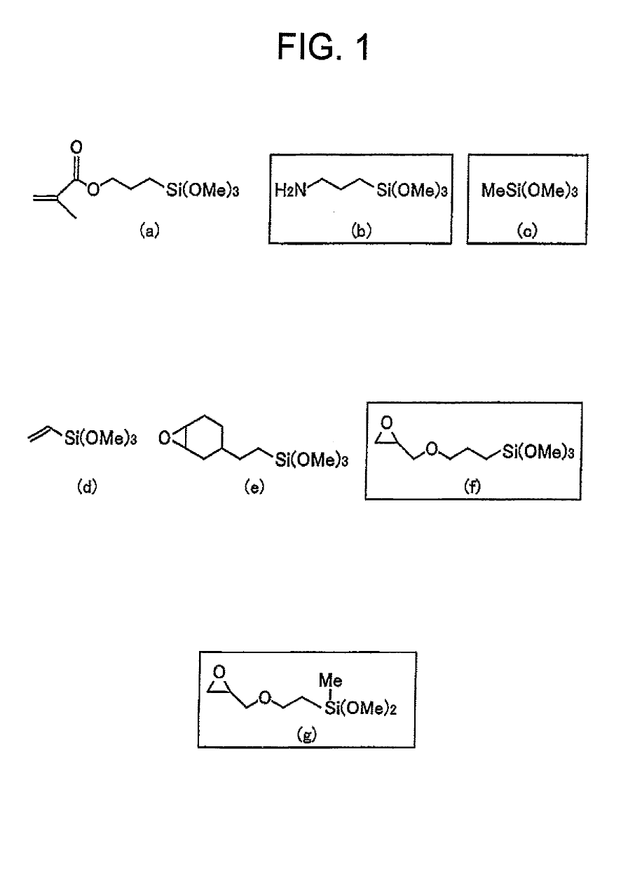

The following were used as a silane treatment agent (refer to FIG. 1):
(a) 3-(trimethoxysilyl)propylmethacrylate,
(b) 3-aminopropyltrimethoxysilane,
(c) methyltrimethoxysilane,
(d) vinyltrimetoxysilane,
(e) 2-(3,4-epoxycyclohexyl)ethyltrimethoxysilane,
(f) 3-glycidoxypropyltrimethoxysilane, and
(g) 3-glycidoxypropyl(dimethoxy)methylsilane.

Specifically, a silane treatment agent (stock solution) was added to an ITO dispersion so that the addition ratio of the silane treatment agent to ITO particles (solids) will be 10%, and the mixture was stirred at room temperature for about 17 h. As a result, when the silane treatment agent (a), (b), or (d) was added, the color of the modified-ITO dispersion slightly turned to bluish white.

Three days after the preparation of the modified-ITO dispersions, the modified-ITO dispersion obtained by use of the silane treatment agent (a) or (d) gelled, and in the case of the silane treatment agent (e), a part of the resulting dispersion also gelled. On the other hand, in the case where the silane treatment agent (b), (c), (f), or (g) (that enclosed by a rectangular frame in FIG. 1) was used, it was verified that the modified-ITO dispersion maintained a stable state without gelling about 1 week.

(B-3) Evaluation of Coating Materials in which Modified-ITO Dispersion and Silane Solution (a-1) are Mixed

Based on the results of the above (B-2), it was attempted to prepare a mixed solution of a modified-ITO dispersion treated with a silane treatment agent (b), (c), or (f) and the silane solution (a-1). Four types of coating materials were provided in which the volume mixing ratios of the modified-ITO dispersion/silane solution (a-1) are 50/50, 40/60, 30/70, and 20/80, respectively; and the coating material was prepared by stirring the mixture at room temperature for 1 h according to the above (A-3). As a result, when the silane treatment agent (b) was used, the coating materials gelled in all the mixing ratios. An amino group present in the silane treatment agent (b) is thought to have accelerated the gelation of the mixed solution. The solution state and the evaluation of the coating films in the case of using the silane treatment agents (c) and (f) were summarized in Table 1.

TABLE 1

| | Volume | | | | |
|---|---|---|---|---|---|
| Silane | mixing | Characteristics of | | Surface characteristics | |
| treatment | ratio | coating material | | of coating film | |
| agent | ITO/Si¹⁾ | Color | Life | Surface state²⁾ | Hardness |
| (c) | 50/50 | Dark | Gelled | Δ | — |
| | | blue | after 1 day | | |
| (c) | 40/60 | Dark | Stable | ∘ | 7H |
| | | blue | after 3 days | | |
| (c) | 30/70 | Dark | Gelled | ∘ | 7H |
| | | blue | after 3 days | | |
| (c) | 20/80 | Bluish | Gelled | x | — |
| | | white | after 1 day | | |
| (f) | 50/50 | Dark | Stable | Δ | — |
| | | blue | after 3 days | | |
| (f) | 40/60 | Dark | Stable | ∘ | 8H |
| | | blue | after 3 days | | |
| (f) | 30/70 | Dark | Stable | ∘ | 8H |
| | | blue | after 3 days | | |
| (f) | 20/80 | Bluish | Gelled | x | — |
| | | white | after 1 day | | |
| (g) | 30/70 | Dark | Stable | ∘ | 4-5H |
| | | blue | after 3 days | | |

¹⁾Si: Silane solution (a-1), ITO: Modified dispersion
²⁾∘: No cloudiness and smooth coating film surface,
Δ: No cloudiness but waviness in coating film surface,
x: With cloudiness and waviness in coating film surface

In the case of using the silane treatment agent (c) or (f) and a mixing ratio of 40/60 or 30/70, cloudiness was not observed in the coating film, but waviness was observed at an edge part, and a smooth coating film surface was obtained. The silane treatment agent (f) provided a slightly better coating film than the silane treatment agent (c).

Similarly, in the case of a mixing ratio of 50/50, cloudiness was not observed in the coating film, but waviness was observed on the coating film surface. Further, in the case of a mixing ratio of 20/80, cloudiness was observed in the coating film, and waviness was observed on the coating film surface.

When the silane treatment agent (c) was used, the coating material having a volume mixing ratio of 40/60 maintained a stable state after 3 days; but the coating material having a volume mixing ratio of 30/70 gelled after 3 days, and the coating material having a volume mixing ratio of 50/50 or 20/80 gelled after 1 day.

Further, when the silane treatment agent (f) was used, the coating material having a volume mixing ratio of 20/80 was gelled after 1 day, but the coating materials having other mixing ratios maintained a stable state even after 3 days. Both in the case of using the silane treatment agents (c) and (f), the life of the coating materials was short and the uniformity of the resulting coating films was poor when the mixing ratio of the modified-ITO dispersion to the silane solution (a-1) was too high or too low. This has revealed that it is very important to select a suitable volume mixing ratio (25/75 to 55/45, preferably 25/75 to 45/55) in the coating material preparation stage.

Further, when the mixing ratio of the modified-ITO dispersion to the silane solution (a-1) is low, the color of the coating material is frequently bluish white, and in this case, a tendency was observed that the life of the coating material was short and the coating film became cloudy.

Note that, in the preparation of a modified-ITO dispersion using the silane treatment agent (f), when a modified-ITO dispersion obtained by a short-time stirring of 1 h at room temperature is used, the surface of the coating film formed from the coating material using this modified-ITO dispersion became nonuniform. This is probably because the silane treatment agent (f) has not completely reacted with the ITO particles. As a result, it was found that the reaction of the silane treatment agent (f) with the modified-ITO dispersion requires sufficient stirring time.

Next, in the case of both the silane treatment agent (c) and the silane treatment agent (f), a coating material having a volume mixing ratio of 40/60 or 30/70 was applied to a glass substrate and dried at room temperature for 1 day. The resulting coating film was measured for the pencil hardness. As a result, both the coating materials each having a volume mixing ratio of 40/60 or 30/70 showed a high value of 7H in the case of using the silane treatment agent (c) and 8H in the case of using the silane treatment agent (f). Further, these 4 types of coating films were subjected to the peeling test. As a result, none of the coating films has peeled off at all.

From the above results, it was found that the silane treatment agent (f) having a glycidoxy group is the optimum in the preparation of a modified-ITO dispersion, and when the state of the coating film surface obtained is taken into consideration, a coating material having a mixing ratio of modified-ITO dispersion/silane solution (a-1) of 30/70 is the optimum.

Further, in the use of the silane treatment agent (f), dispersions were prepared in which the addition ratio (to ITO particles) of the silane treatment agent to be added to a modified-ITO dispersion was changed from 10% to 5% and 20%. These dispersions were each mixed with the silane solution (a-1) at a mixing ratio of modified-ITO dispersion/silane solution (a-1) of 30/70 to prepare coating materials, which were used to prepare coating films. As a result, when the addition ratio was 5%, coating materials having any mixing ratio provided slightly cloudy coating films.

When the addition ratio of the silane treatment agent for a modified-ITO dispersion was 20%, a stable coating material was obtained as when the addition ratio was 10%, and it was possible to prepare a coating film having a smooth (uniform) surface which was not peeled off in the peeling test at all.

With respect to the life of the coating material, when the addition ratio of the silane treatment agent was 10%, the resulting coating material was stable for about 3 days, but gelled after 1 week. On the other hand, when the addition ratio of the silane treatment agent was 20%, the resulting coating material maintained a stable state even after 1 week.

However, when the coating film obtained from a coating material having a treatment agent addition ratio of 20% was measured for the hardness, it was 7H, which was lower by about 1H than in the case where the treatment agent addition ratio was 10%. Consequently, it was found that when priority was given to the hardness of a coating film, an addition ratio of around 10% is the optimum in the case of the silane treatment agent (f).

Further, it was attempted to prepare a coating material and a coating film by using the silane treatment agent (g) in which one methoxy group in the silane treatment agent (f) was replaced by a methyl group and applying the optimum condition in the silane treatment agent (f). As a result, a coating film was obtained in which the surface uniformity was slightly improved compared with the case of the silane treatment agent (f), but the hardness was 4 to 5H, which was significantly lower than the coating film obtained by using the silane treatment agent (f). From these results, it was able to be reconfirmed that although it was difficult to use the silane treatment agent (g) when the reduction in the hardness of a coating film is taken into consideration, a glycidoxy group (epoxy group) which was commonly present in the silane treatment agents (f) and (g) was effective from the viewpoint of uniforming the surface of the coating film.

Next, a coating film was formed from a coating material in which a modified-ITO dispersion having an addition ratio of the silane treatment agent (f) of 10% was used, and the modified-ITO dispersion was mixed with the silane solution (a-1) in a volume mixing ratio of modified-ITO dispersion/silane solution (a-1) of 30/70. The resulting coating film was measured for the transmittance. However, a large number of cracks and fracture occurred on the surface of the coating film after the completion of the measurement. This is probably because the coating film was rapidly heated by light irradiation. Then, in order to improve the problem, a method of preparing a coating material, a method of forming a coating film, and the like were reinvestigated, but it was impossible to prevent the surface deterioration of the coating film by heating. Therefore, it was determined to improve the silane solution (a-1) as a solution.

### (B-3) Evaluation and Selection of Silane Solution

As one of the causes by which the coating film has deteriorated by heating, the silicone coating film composed only of TEOS has the property of brittleness which is inherent in the coating film of three-dimensional siloxane bonds in general. This inherent property was probably promoted in the state where ITO particles were dispersed in the silicone coating film, showing the brittleness at the rapid heating.

Then, it was determined to investigate the above-described mixed silane solutions (c-1), (c-2), and (c-3) obtained by adding MTMOS to the silane solution (a-1) composed only of TEOS. It was able to verify that flexibility can be imparted to the coating film composed only of TEOS because MTMOS has a methyl group on silicon. As a result, it was found that the molar mixing ratio of trialkoxysilane/tetraalkoxysilane was preferably in the range of 5/95 to 35/65 (more preferably, 25/75 to 35/65).

The modified-ITO dispersion (to which 10% of silane treatment agent (f) is added) was mixed with the mixed silane solution (c-1), (c-2), or (c-3) in a mixing ratio of modified-ITO dispersion/mixed silane solution of 30/70 to prepare a mixed solution, from which a coating film was prepared.

As a result, a coating film having a smooth surface and high adhesion was obtained in the case where any mixed silane solution (c-1), (c-2), or (c-3) is used.

Next, these coating films were dried at room temperature for 1 day and then heat-treated at 100° C. for 30 min in order to investigate heat resistance. When the state of the coating film surface after the treatment was checked, defects such as fracture and peeling of a coating film decreased as the amount of MTMOS was increased, and the coating film defects were not substantially observed when the mixed silane solution (c-3) of an MTMOS/TEOS (molar ratio) of 30/70 was used. Consequently, the mixed silane solution (c-3) was regarded as the optimum mixed silane solution.

The hardness of this coating film was measured to be 7H. Further, when a heating time of 2 h at 70° C. was increased to 4 h in the preparation of the mixed silane solution (c-3), the coating film had a hardness (8H, improved by 1H) equal to or higher than that under the 2-h condition and in addition had high adhesion and heat resistance.

In addition, solutions were prepared by mixing not only in a volume mixing ratio of modified-ITO dispersion/mixed silane solution of 30/70, but also in volume mixing ratios of 50/50, 40/60, and 20/80 to prepare coating films. As a result, uniform coating films having high adhesion were obtained from 3 types of solutions having volume mixing ratios of a modified-ITO dispersion/mixed silane solution of 50/50, 40/60, and 30/70.

In the case of the silane solution (a-1), a solution having a volume mixing ratio of 50/50 provided a coating film having a stripe-shaped pattern on the surface thereof, but in the case of the mixed silane solution (c-3), a solution having a volume mixing ratio of 50/50 provided a smooth coating film. However, a solution having a volume mixing ratio of 20/80 provided a cloudy coating film as in the case of the silane solution (a-1).

These 3 types of coating films were dried at room temperature for 1 day and then even heat-treated at 100° C. for 30 min, but almost no fracture and peeling was observed on the surface of the coating films. However, when the hardness of the coating films after drying at room temperature for 1 day was measured, the hardness was 6H for the volume mixing ratio of 50/50 and 7H for the volume mixing ratio of 40/60. These values were slightly lower than the hardness of 8H for the mixing ratio of 30/70.

Next, a coating film was formed from a coating material in which a mixed silane solution (c-3) and a modified-ITO dispersion (10% of silane treatment agent (f) is added) are used in a volume mixing ratio of modified-ITO dispersion/mixed silane solution (c-3) of 30/70. The resulting coating film was measured for the transmittance in a measurement wavelength range of 800 to 2600 nm.

In FIG. 2 showing the results of the measurement, the transmittance was about 80% in the vicinity of a wavelength of 800 nm, continuously decreased with an increase in the wavelength, and was about 0% in a wavelength range of 1500 to 2600 nm. Note that an untreated glass substrate generally has a high transmittance of about 90% over the whole measurement wavelength range.

From these results, it has been verified that heat rays (near-infrared rays) can be significantly shielded by forming this coating film on a glass substrate. In addition, no defects were observed on the surface of this heat-shielding coating film even after the completion of the measurement of transmittance.

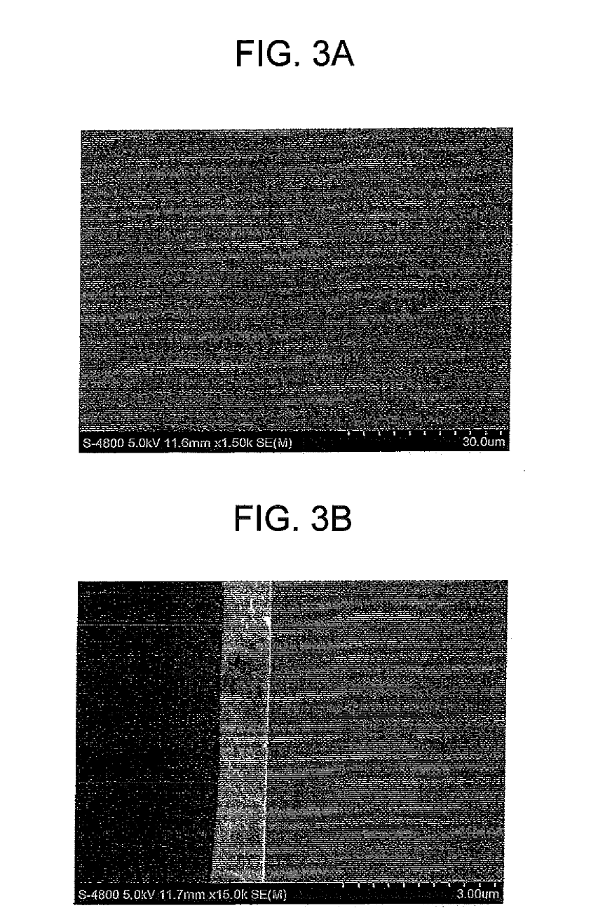

Further, FIG. 3 shows a SEM photograph of (FIG. 3A) the state of the coating film surface and (FIG. 3B) the cross section of this coating film. From FIG. 3A, it was able to be verified that the coating film surface does not have a defect such as fracture and peeling and is smooth. Further, from FIG. 3B, there was observed a state where ITO particles were uniformly and closely dispersed, and the thickness of the coating film was found to be about 1 μm.

### C. DISCUSSION AND CONCLUSIONS

The results obtained from the above tests will be summarized below.

1) A method for preparing a coating material having a practical life without gelation was investigated, wherein the coating material comprises a silane solution obtained by use of TEOS as the main raw material and hydrochloric acid as a catalyst and a modified-ITO dispersion, the solution and the dispersion being mixed for service.

First, various silane treatment agents were allowed to react with an ITO dispersion in order to chemically modify the surface of ITO particles. Next, as a result of attempting to mix the resulting modified-ITO dispersion with the silane solution (a-1), it was found that a stable coating material can be prepared when the silane treatment agent (f) was used.

2) When the coating material obtained in the above 1) was used under room-temperature drying to prepare a coating film on a glass substrate, a uniform and close coating film without a defect such as fracture and peeling was obtained. This coating film was not peeled at all in the peeling test and had a pencil hardness as high as 8H. However, when the transmittance of the coating film was measured, a large number of fracture and peeling occurred on the surface because the coating film was rapidly heated.

3) After obtaining the results of the above 2), mixed silane solutions (C-1), (C-2), and (C-3) were prepared by mixing TEOS and MTMOS in order to prevent surface deterioration by heating. These solutions were mixed with a modified-ITO dispersion to prepare coating materials, and the resulting coating materials were investigated. As a result, it was found that the addition of MTMOS in a suitable molar ratio (MTMOS/TEOS=5/95 to 35/65) showed that heat resistance is improved compared with the case of using only TEOS.

Finally, it has been found that the coating film formed from a coating material obtained by mixing the mixed silane solution (c-3) in which TEOS and MTMOS are mixed in a suitable molar ratio and the modified-ITO dispersion treated with the silane treatment agent (f) in a predetermined mixing ratio is smooth and excellent in adhesion, has a hardness as high as 8H, and in addition can sufficiently shield near-infrared rays (particularly, about 1500 to 2600 nm).

What is claimed is:

1. A silicone coating material comprising: a silane solution comprising an alkoxysilane hydrolysate; and a dispersion of indium tin oxide (ITO) particles (hereinafter referred to as an “ITO dispersion”), the solution and the dispersion being mixed for service, wherein the ITO dispersion is a modified-ITO dispersion to which a silane treatment agent is added and mixed to subject the ITO particles to silane treatment.

2. The silicone coating material according to claim 1, wherein the silane treatment agent (silane coupling agent) in the silane treatment comprises one or more selected from the group consisting of an ω-glycidoxyalkylalkoxysilane represented by general formula (I): 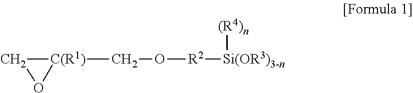
wherein R¹ and R⁴ each represent H or CH₃; R² represents an alkylene group having 1 to 4 carbon atoms; R³ represents an alkyl group having 1 to 4 carbon atoms; and n=0 or 1, and a trialkoxysilane represented by general formula (II):
R⁵Si(OR⁶)₃
wherein R⁵ and R⁶ each represent an alkyl group having 1 to 4 carbon atoms.

3. The silicone coating material according to claim 2, wherein the silane treatment agent is 3-glycidoxypropyltrimethoxysilane (GTMOS) or 3-glycidoxypropyl(dimethoxy)methylsilane.

4. The silicone coating material according to claim 2 or 3, wherein the addition ratio of the silane treatment agent to ITO particles is 3 to 25% by mass.

5. The silicone coating material according to claim 1, 2, or 3, wherein with respect to the volume mixing ratio of the ITO dispersion to the silane solution in the case where the concentration of the silane solution is 0.5 to 1.5 M, and the solids concentration of the modified-ITO dispersion is 30 to 40% by mass, the volume mixing ratio of modified-ITO dispersion/silane solution is 25/75 to 55/45.

6. The silicone coating material according to any one of claims 1 to 5, wherein the silane solution is a mixed silane solution comprising a mixed hydrolysate of a tetraalkoxysilane (component A) represented by general formula (III): Si(OR⁷)₄ wherein R⁷ represents an alkyl group having 1 to 4 carbon atoms as well as a trialkoxysilane (component B) represented by general formula (IV): R⁸Si(OR⁹)₃ wherein R⁸ and R⁹ each represent an alkyl group having 1 to 4 carbon atoms, wherein the mixed hydrolysate mainly comprises the component A.

7. The silicone coating material according to claim 6, wherein the molar mixing ratio of the component B to the component A in the mixed silane solution (component B/component A) is 5/95 to 35/65.

8. The silicone coating material according to claim 6 or 7, wherein the component A is tetraethoxysilane (TEOS), and the component B is methyltrimethoxysilane (MTMOS).

9. A transparent substrate having a heat-shielding structure comprising a transparent substrate and a heat-shielding coating film formed on the substrate, wherein the coating film is formed from a silicone coating material according to any one of claims 1 to 8.
